(19) United States
(12) Patent Application Publication
(10) Pub. No.: US 2026/0193837 A1
(43) Pub. Date: Jul. 9, 2026

(54) BRIDGE ROPE ASSEMBLY AND METHODS FOR MANUFACTURING THE SAME

(71) Applicant: Latitude Outdoors, LLC, Grand Rapids, MI (US)

(72) Inventors: Kevin Leach, Grand Rapids, MI (US); Jake Matelic, Royal Oak, MI (US); Alex Chopp, Royal Oak, MI (US)

(21) Appl. No.: 19/416,482

(22) Filed: Dec. 11, 2025

Related U.S. Application Data
(60) Provisional application No. 63/742,160, filed on Jan. 6, 2025.

(51) Int. Cl. D07B 1/00

(52) U.S. Cl. CPC D07B 1/00; D04C 1/12; D04C 3/48; D07B 2201/1096; D07B 2801/24; D07B 2801/60

(57) ABSTRACT

A method for manufacturing a bridge for a tree saddle includes forming a bight in a rope that extends between a first rope end and a second rope end. The rope includes a first extent extending between the first rope end and an intermediate extent of the rope and a second extent extending between the second rope end and the intermediate extent. The method further comprises weaving a plurality of strands around the rope between the first and second rope ends and the intermediate extent to form a sheath around the first and second extents and expose the intermediate extent outside of the sheath.

### CROSS-REFERENCE TO RELATED APPLICATIONS

This application claims priority to U.S. Application No. 63/742,160, entitled BRIDGE ROPE ASSEMBLY, the disclosure of which is hereby incorporated herein by reference in its entirety.

### FIELD OF THE DISCLOSURE

The present disclosure generally relates to a bridge rope assembly and methods for manufacturing the same. More particularly, the present disclosure relates to methods for manufacturing bridges for saddles.

### BACKGROUND OF THE DISCLOSURE

Tree saddles often utilize bridge ropes.

### SUMMARY OF THE DISCLOSURE

According to a first aspect of the present disclosure, a method for manufacturing a bridge for a tree saddle is provided. The method comprises forming a bight in a rope that extends between a first rope end and a second rope end, wherein the rope includes a first extent extending between the first rope end and an intermediate extent of the rope and a second extent extending between the second rope end and the intermediate extent. The method comprises weaving a plurality of strands around the rope between the first and second rope ends and the intermediate extent to form a sheath around the first and second extents and expose the intermediate extent outside of the sheath.

Embodiments of the first aspect of the disclosure can include any one or a combination of the following features:
positioning the intermediate extent between a pair of the plurality of strands prior to weaving the plurality of strands around the rope;
the bight is formed without splicing the rope;
the bight is formed without unweaving the sheath;
weaving the plurality of strands together to form a first part of a braid beyond a first sheath end adjacent the bight;
weaving the plurality of strands together beyond the first end and the second end to a position spaced from the rope to form a second part of the braid, and decoupling each of the first part and the second part from the sheath;
stitching together the sheath and the rope at a first sheath opening adjacent the intermediate extent;
heat-shrinking material around the sheath adjacent the first sheath opening;
heat-shrinking material around the sheath adjacent the first end and the second end;
forming a stopper knot nearer to the first and second ends than to the intermediate extent;
the bight is defined by a section of the rope that extends along a first portion of the first extent that is between the knot and the intermediate extent, along the intermediate extent, and along a second portion of the second extent that is between the intermediate extent and the knot; and
the rope extends along a rope axis, wherein a first segment of the rope axis extending along an entirety of the first portion is non-colinear with a second segment of the rope axis extending along an entirety of the second portion.

According to a second aspect of the present disclosure, a method is provided comprising forming a bend in each of a plurality of ropes that each extend between a first end and a second end, wherein each rope includes a first extent extending between the first rope end and an intermediate extent of the rope and a second extent extending between the second rope end and the intermediate extent. The method comprises weaving a plurality of strands around a first rope of the plurality of ropes between the first and second rope ends and the intermediate extent of the first rope to form a first sheath, and weaving the plurality of strands around a second rope of the plurality of ropes between the first and second rope ends and the intermediate extent of the second rope to form a second sheath.

Embodiments of the second aspect of the disclosure can include any one or a combination of the following features:
positioning the intermediate extent of the first rope between a pair of the plurality of strands prior to weaving the plurality of strands around the first rope;
the intermediate extent of the first rope is formed without splicing the first rope;
the intermediate extent of the first rope is formed without unweaving the first sheath;
weaving the plurality of strands together to form a first part of a braid beyond the bend of the first rope;
weaving the plurality of strands together beyond the first end and the second end of the first rope to a position spaced from the first rope to form a second part of the braid, and decoupling each of the first part and the second part from the sheath; and
stitching together the first sheath and the first rope at an opening of the first sheath adjacent the intermediate extent.

According to a third aspect of the present disclosure, a method for manufacturing bridges for saddles is provided. The method comprises forming a bight in each of a plurality of ropes that each extend between a first end and a second end, wherein each rope includes a first extent extending between the first rope end and an intermediate extent of the rope and a second extent extending between the second rope end and the intermediate extent. The method comprises weaving a plurality of strands around a first rope of the plurality of ropes between the intermediate extent of the first rope and the first and second ends of the first rope to form a first sheath around the first and second extents of the first rope, weaving the plurality of strands together beyond the first end and the second end of the first rope to a position spaced from the first rope, positioning the bight of a second rope at the position spaced from the first rope, and weaving the plurality of strands around the second rope between the intermediate extent of the second rope and the first and second ends of the second rope to form a second sheath around the first and second extents of the second rope.

According to a fourth aspect of the present disclosure, a method of making a tree saddle bridge that includes a rope extending between a first end and a second end includes forming a bight in the rope and weaving a plurality of strands around the rope between the bight and the first and second ends to form a sheath around the rope.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a tree saddle securing a user to a tree;

FIG. 2 is a perspective view of a tree saddle;

FIG. 3 is a side plan view of a bridge for the tree saddle;

FIG. 4A is a functional diagram of a part of a process for forming bridges for saddles;

FIG. 4B is a functional diagram of a subsequent part of the process of FIG. 4A;

FIG. 5 is a plan view of an exemplary braiding system;

FIG. 6 is a perspective view of a portion of an exemplary braiding system;

FIG. 7 is a perspective view of a portion of a braid demonstrating a bight of a bridge formed with the braid;

FIG. 8 is a flow diagram of a method for manufacturing a bridge for a tree saddle; and

FIG. 9 is a flow diagram of a method for manufacturing bridges for saddles.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along the axis of a shaft configured to rotate in operation of the apparatus described herein. Further, the term “radial” and derivatives thereof, such as “radially,” shall be understood in relation to the axis of the aforementioned shaft. For example, “radially outboard” refers to further away from the axis, while “radially inboard” refers to nearer to the axis. The term “circumferential” and derivatives thereof, such as “circumferentially,” shall be understood in relation to the axis of the aforementioned shaft.

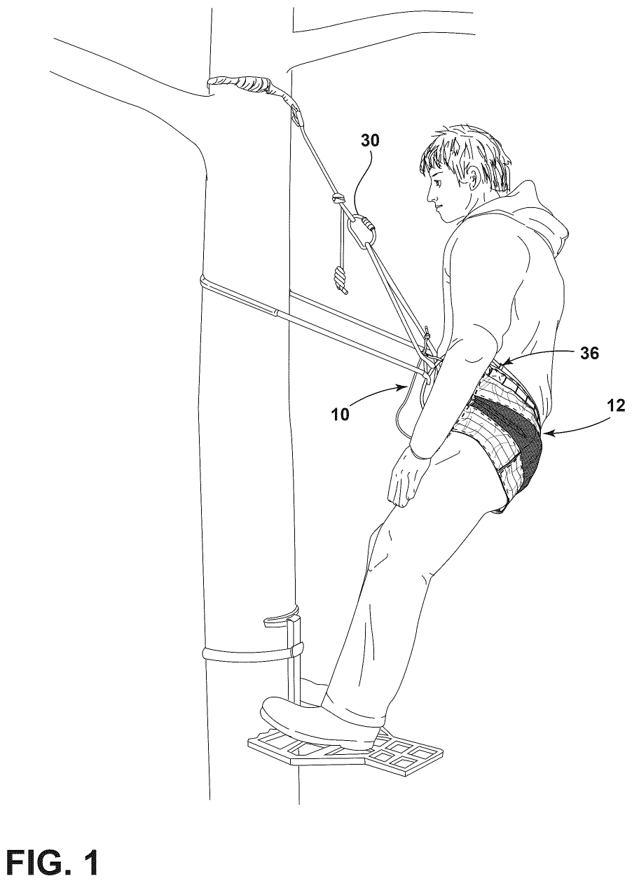

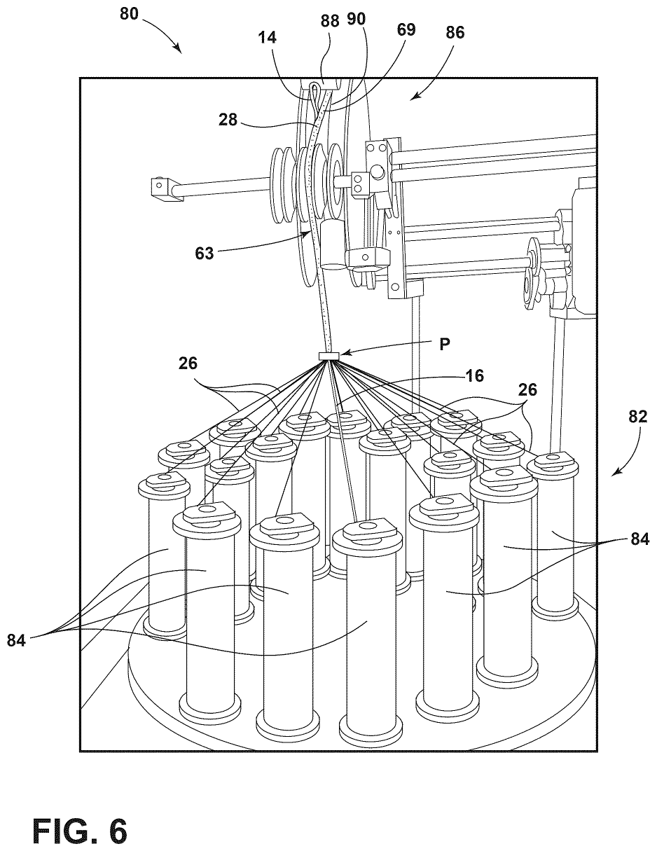

Referring to FIGS. 1-9, a method for manufacturing a bridge 10 for a tree saddle 12 includes forming a bight 14 in a rope 16 that extends between a first rope end 18 and a second rope end 20. The rope 16 includes a first extent 22 extending between the first rope end 18 and an intermediate extent 23 and a second extent 24 extending between the second rope end 20 and the intermediate extent 23. The method includes weaving a plurality of strands 26 around the rope 16 between the first and second rope ends 18, 20 and the intermediate extent 23 to form a sheath 28 around the first and second extents 22, 24 and expose the intermediate extent 23 outside of the sheath 28.

It is contemplated that the sheath 28 can extend from the first and second rope ends 18, 20 to termini 29 of the intermediate extent 23. For example, the intermediate extent 23 can extend between a first terminus that is continuous with the first extent 22 and a second terminus that is continuous with the second extent 24. The termini 29 can be disposed at the first opening 46. It is contemplated that the rope 16 can have other formations instead of or in addition to the bight 14. For example, the rope 16 can employ any type of bend, at least a portion of which can extend outside of the sheath 28. The rope 16 can form a double bight. Thus, the specific shapes of the rope 16 within and/or extending outside of the sheath 28 can include one or more of a variety of bends.

Referring to FIG. 1, an example of a tree saddle 12 employing a bridge 10 constructed according to the methods described herein is shown in use for attaching to a tree. The bridge 10 can secure the saddle 12 to another fastening structure, such as a rope and clip, that can be secured to the tree. The bridge 10 can be in the form of a bridge rope assembly that couples with the tree saddle 12 and loops through an attachment feature 30 attached to the tree. It is contemplated that the bridge 10 can also be used for purposes other than tree saddles.

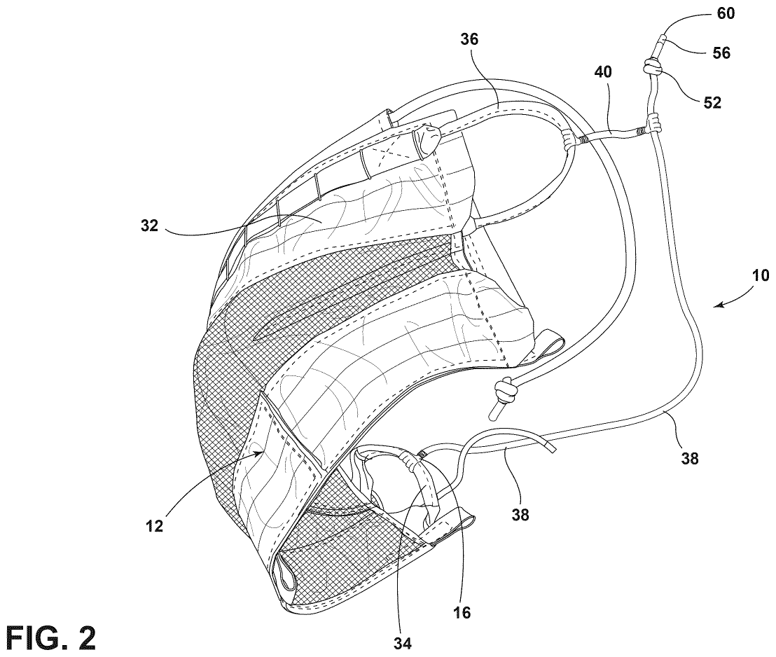

Referring to FIGS. 1-2, a tree saddle 12 and the bridge 10 are shown. The tree saddle 12 includes a support panel 32 configured to cradle a portion of a user (for example legs, buttocks, back). The tree saddle 12 further includes a first bridge loop 34 and a second bridge loop 36. The first bridge loop 34 is coupled to the support panel 32 near a first end, and the second bridge loop 36 is coupled near the opposite end. The first and second bridge loops 34, 36 are configured to engage with the bridge 10.

With reference to FIGS. 1-2, the tree saddle 12 engages with the bridge 10. In the embodiment illustrated in FIG. 2, the main body 38 of the bridge 10 engages with the first bridge loop 34 of the tree saddle 12. A friction hitch 40 can engage with the main body 38 of the bridge 10 and be configured to engage with the second bridge loop 36 of the tree saddle 12. In operation, a rope or strap with an attachment feature 30 (for example a carabiner) is engaged with a tree, and the main body 38 of the bridge 10 extends through the attachment feature 30 for slidable engagement. The tree saddle 12 engages with the bridge 10 (the first bridge loop 34 with the main body 38 and the second bridge loop 36 with the friction hitch 40), such that the tree saddle 12 can be suspended from the tree and support a user. The tree saddle 12 includes the support panel 32, the first bridge loop 34, and the second bridge loop 36.

Referring generally to FIGS. 1-3, the bridge 10 includes the main body 38, which includes a sheath 28. The sheath 28 extends from a first sheath end 42 to a second sheath end 44 and defines an interior volume from a first opening 46 to a second opening 48. The main body 38 further includes a rope 16 extending from a first rope end 18 to a second rope end 20. The rope 16 includes a first extent 22 extending from the first rope end 18 toward the second rope end 20, an intermediate extent 23 extending from the first extent 22 toward the second rope end 20, and a second extent 24 extending from the intermediate extent 23 to the second rope end 20.

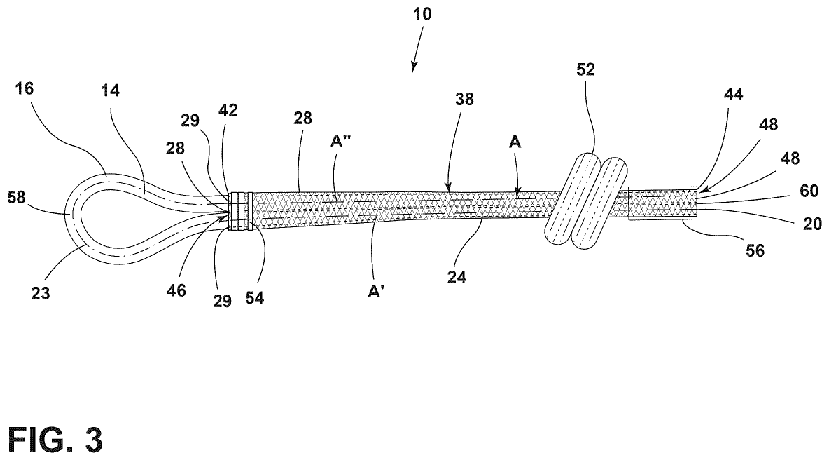

Referring to FIG. 3, the rope 16 is arranged such that at least a portion of the first extent 22 extends within the interior volume of the sheath 28 through the first opening 46, and at least a portion of the second extent 24 extends within the interior volume through the same opening, alongside the first extent 22. The intermediate extent 23 forms the bight 14 outside the sheath 28 that engages with the first bridge loop 34 of the tree saddle 12.

A portion of the main body 38 in which the first and second extents 22, 24 of the rope 16 extend within the sheath 28 alongside each other is tied into a knot 52 (for example, a stopper knot). The knot 52 can be positioned between the intermediate extent 23 and the first and second rope ends 18, 20. The intermediate extent 23, the portion of the first extent 22 between the intermediate extent 23 and the knot 52 (a first portion), and the portion of the second extent 24 between the intermediate extent 23 and the knot 52 (a second portion) form a bight 14. The friction hitch 40 of the bridge 10 is engaged with the main body 38 between the first sheath end 42 and the knot 52 and is engaged with the second bridge loop 36 of the tree saddle 12.

Referring to FIG. 3, in some examples, the first and second rope ends 18, 20 are positioned adjacent to the second sheath end 44 and/or within the interior volume of the sheath 28. In some examples, the main body 38 includes a heat-shrink sleeve 54 disposed around the sheath 28. For example, a first heat-shrink sleeve 54 can be disposed near the first sheath end 42, and a second sleeve 56 can be positioned near the second sheath end 44 and the rope ends 18, 20.

The main body 38 includes a first main body end 58 formed by the intermediate extent 23 of the rope 16 and a second main body end 60 distal from the first main body end 58. The second main body end 60 may be near the second heat-shrink sleeve 56, the second sheath end 44, and the rope ends 18, 20. The main body 38 extends along its length from the first main body end 58 to the second. The knot 52 is positioned between these ends 58, 60, nearer to the second end 60 than to the first end 58. In the extended condition, the main body 38 is held taut between the first and second ends 58, 60. The intermediate extent 23 may form a gently curving loop, but could also be oriented differently (for example a sharp fold with generally parallel rope portions). The rope 16 extends along a rope axis A, with a first segment A′ of the rope axis A along the first portion and a second segment A″ of the rope axis A extending along the second portion, which can be non-colinear.

By way of example, the first portion and the second portion can run parallel to one another without the first portion crossing over the second portion, and vice versa. For example, neither the first nor the second may form a helix. By way of example, if the first segment A′ is disposed above a central axis of the main body 38, then the second segment A″ can be disposed below the central axis of the main body 38. The first portion can cross over the second portion at the knot 52.

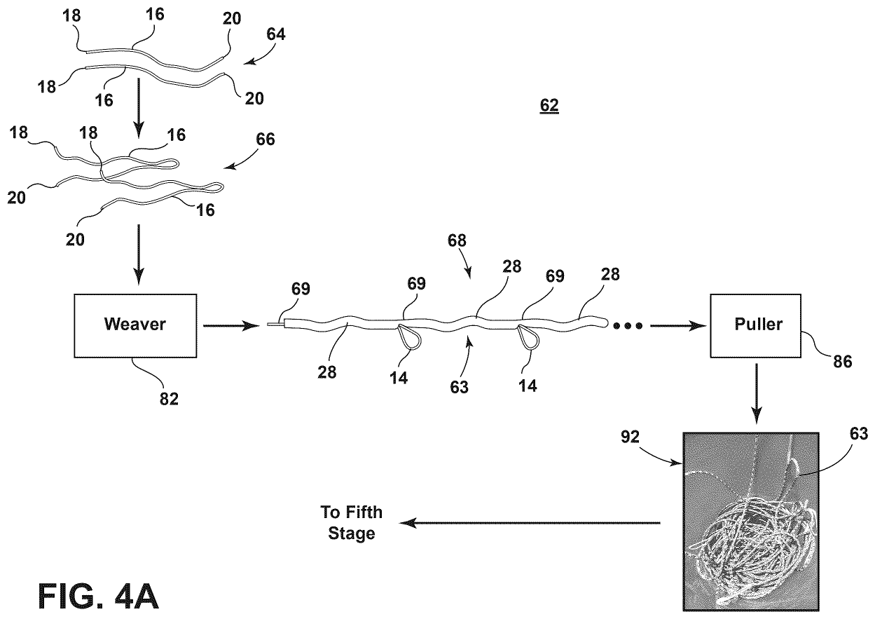

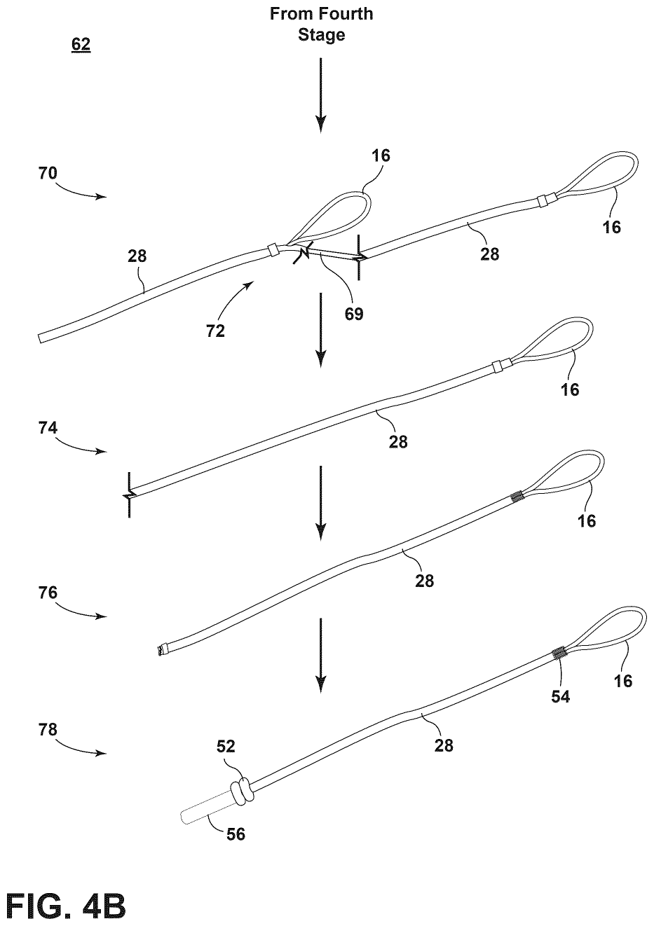

Referring now to FIGS. 4A and 4B, an exemplary process 62 for forming bridges 10 from a braid 63 is demonstrated. At a first stage 64, ropes 16 are prepared, possibly cut from a longer rope into sections (ropes 16) corresponding to each bridge 10. At a second stage 66, an intermediate portion 23 is formed in each rope 16 by pinching or manipulating the rope 16 so that the extents 22, 24 run alongside each other. For example, the first extent 22 may abut or may be proximate the second extent 24. In some examples, the first and second extents 22, 24 remain parallel without crossing. In some embodiments, the bight 14 is formed without splicing the rope 16 or unweaving the sheath 28. At a third stage 68, a weaver 82 applies strands 26 around the first and second extents 22, 24 of each rope 16, starting at the termini 29 of the intermediate extent 23 and moving toward the ends 18, 20, forming a sheath 28.

Before weaving begins, the intermediate extent 23 can be positioned between a pair of strands 26 to expose the bight 14 outside of the interior volume. The sheath 28 may be stitched to the rope 16 near the first sheath end 42 after the rope 16 enters the first opening 46. Continuous weaving may create braid parts lacking inner layers (e.g., ropes 16), which may be referred to as hollow portions 69. By way of example, a hollow portion 69 that extends from a sheath 28 adjacent a first end of the sheath 28 may be referred to as a first part of the braid 63, and a hollow portion 69 that extends from the sheath 28 adjacent a second end of the sheath 28 may be referred to as a second part of the braid 63. Accordingly, a first part of the braid 63 in relation to a first sheath 28 and a second part of the braid 63 in relation to a second sheath 28 sequentially adjacent to the first sheath 28 in the braid 63 may refer to the same hollow portion 69 of the braid 63.

At stages four through eight 70, 72, 74, 76, 78, the individual bridges 10 are formed by applying tape to the bridge 10 at the sheath ends 42, 44 at stage four 70, cutting adjacent the sheath ends 42, 44 the hollow portions 69 away at stage five 72, trimming the ends of the sheath 28 and any exposed rope 16 at stage six 74, and stitching frayed material of the sheath 28 adjacent the first sheath end 42 at stage seven 76. At the eighth stage 78, heat-shrink sleeves 54, 56 are applied to each sheath end 42, 44, and the second sheath end 44 is manipulated to form the stopper knot 52. By way of example, heat-shrink tubing can be slid over each sheath end 42, 44, then warmed, thereby constricting and radially tightening around each sheath end 42, 44. Following the eighth stage 78, the bridge 10 is formed. At least one of the fourth through the eighth stages 70-78 may be performed manually or automatically via a machine.

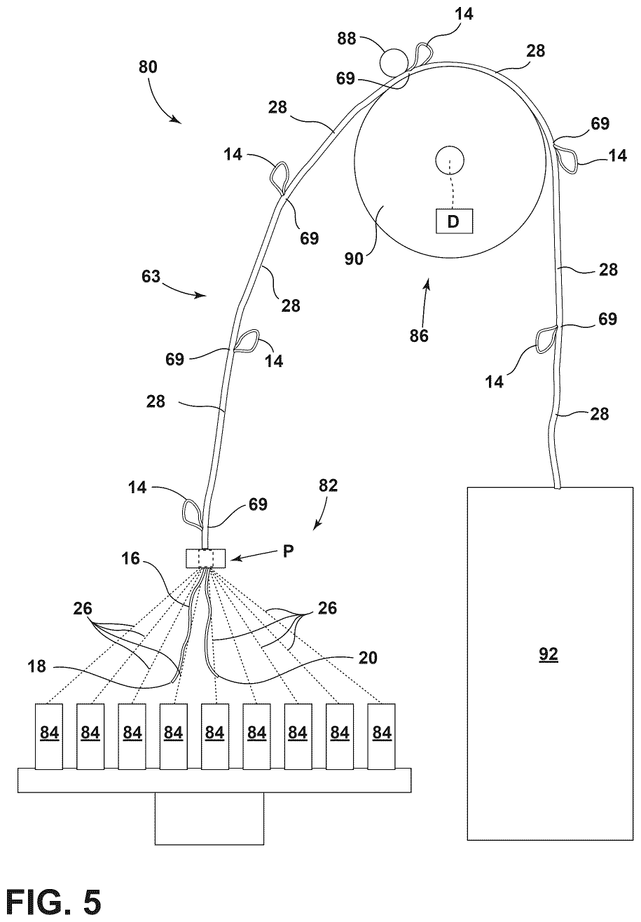

Referring now to FIGS. 5-7, an example of the process 62 is demonstrated. As shown, a braiding system 80 is used to form the sheath 28. The braiding system 80 includes a weaver 82 and a puller 86. The weaver 82 comprises a plurality of spools 84 of strands 26 that spin and/or move concentrically and/or travel in a predefined pattern in a fixture and supply the strands 26 to a convergence point P above the plurality of spools 84. The puller 86 pulls the strands 26 upwardly via, for example, an electrical drive device D such as a motor. As the puller 86 pulls, the spools 84 can provide tension on the strands 26 as the strands 26 are interwoven starting at the convergence point P and along a pull axis. A rope 16 is inserted adjacent the convergence point P. The insertion process may be performed manually or automatically and is done following formation of an intermediate extent 23 by, for example, pinching the rope 16 together at the termini 29. In some examples, the bights 14 are already formed and secured with an adhesive (for example tape).

When the rope 16 is inserted, the intermediate extent 23 extends away from the pull axis and between a pair of strands 26, thereby hanging from the continuous weave of the strands 26 (the braid 63). As the puller 86 pulls the strands 26, the strands 26 are woven around the rope 16 starting at the termini 29 and moving toward the rope ends 18, 20, and the rope 16 is pulled along with the strands 26. The strands 26 continue to be woven past the second rope end 20 resulting in the hollow portion 69 that lacks the rope 16 disposed radially inward of the sheath 28. In operation, ropes 16 are inserted sequentially, one after the next, with slight gaps being formed in the braid 63 therebetween at the hollow portions 69. A resulting daisy chain of bridges 10 is demonstrated in FIG. 5 and can also be seen in FIG. 4. After weaving beyond the rope ends 18, 20, the hollow portion 69 (or braid part) can be decoupled from the sheath 28 to separate individual bridges 10.

It is noted that the puller 86 can include a tensioner 88 that cooperates with a primary wheel 90 to maintain tension on the continuous braid 63. The braid 63 can be deposited into a container 92 or may be fed into another machine that performs at least one of the fourth through eighth stages 70-78 in which the bridges 10 are separated and finalized.

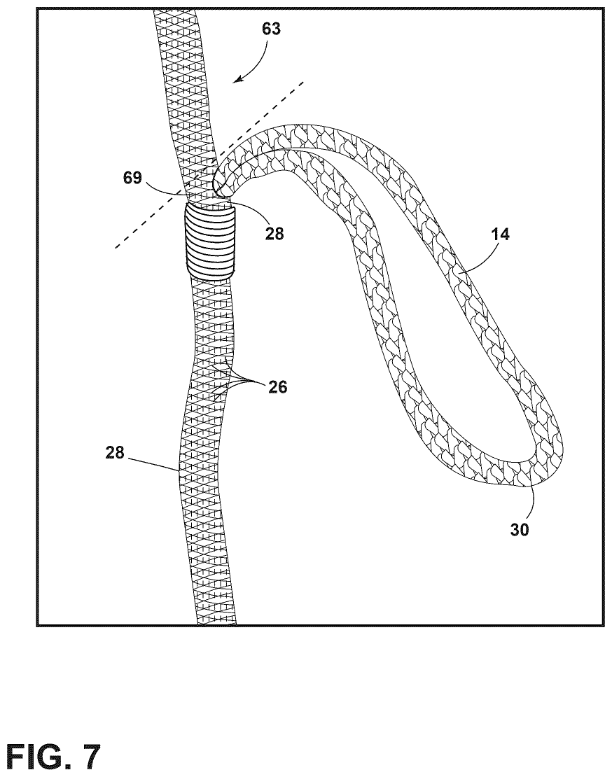

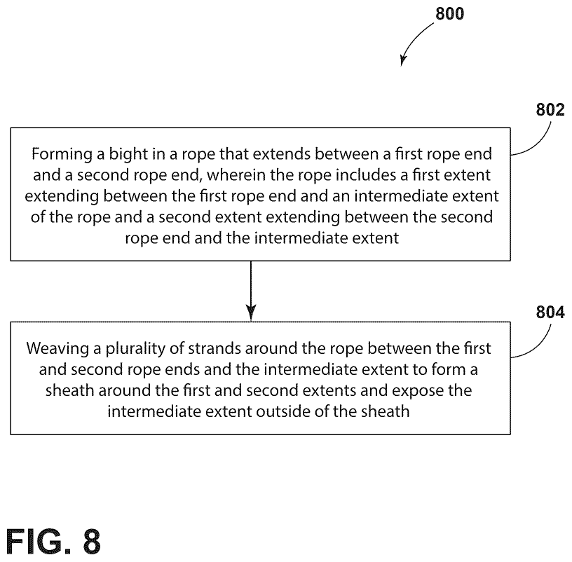

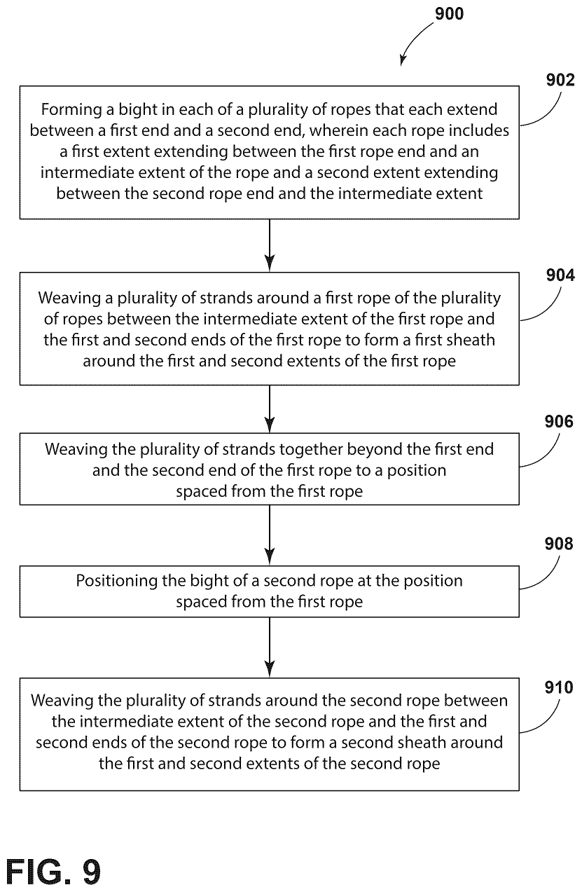

Referring particularly to FIG. 7, the external portion of the bight 14 is shown. In particular, the intermediate extent 23 of the rope 16 is demonstrated between the termini 29 of the intermediate extent 23 extending out of the first opening 46 of the sheath 28. Alongside the intermediate extent 23 is a hollow portion 69 that is a continuation of the braid 63. The location adjacent the first opening 46 that is taped is also shown. The tape 70 can provide radial compression on the sheath 28 to limit unwanted tearing during cutting off of the hollow portion 69 and trimming of the sheath 28. Referring now to FIGS. 8 and 9, exemplary methods of manufacturing are demonstrated.

With reference to FIG. 8, a method 800 for manufacturing a bridge 10 for a tree saddle 12 includes forming a bight 14 in a rope 16 that extends between a first rope end 18 and a second rope end 20 at step 802. The rope 16 includes a first extent 22 extending between the first rope end 18 and an intermediate extent 23 of the rope 16 and a second extent 24 extending between the second rope end 20 and the intermediate extent 23. The method 800 includes weaving a plurality of strands 26 around the rope 16 between the first and second rope ends 18, 20 and the intermediate extent 23 to form a sheath 28 around the first and second extents 22, 24 and expose the intermediate extent 23 outside of the sheath 28 at step 804. It is contemplated that the method 800 can be performed in combination with any of the process stages 64-78 described herein.

With reference to FIG. 9, a method 900 for manufacturing bridges 10 for saddles 12 includes forming a bight 14 in each of a plurality of ropes 16 that each extend between a first end 18 and a second end 20 at step 902, wherein each rope 16 includes a first extent 22 extending between the first rope end 18 and an intermediate extent 23 of the rope 16 and a second extent 24 extending between the second rope end 20 and the intermediate extent 23. The method 900 includes weaving a plurality of strands 26 around a first rope 16 of the plurality of ropes 16 between the intermediate extent 23 of the first rope 16 and the first and second ends 18, 20 of the first rope 16 to form a first sheath 28 around the first and second extents 22, 24 of the first rope 16 at step 904. The method 900 includes weaving the plurality of strands 26 together beyond the first end 18 and the second end 20 of the first rope 16 to a position spaced from the first rope 16 at step 906. The method 900 includes positioning the bight 14 of a second rope 16 at the position spaced from the first rope 16 at step 908. The method 900 includes weaving the plurality of strands 26 around the second rope 16 between the intermediate extent 23 of the second rope 16 and the first and second ends 18, 20 of the second rope 16 to form a second sheath 28 around the first and second extents 22, 24 of the second rope 16 at step 910. It is contemplated that the method 900 can be performed in combination with any of the process stages 64-78 described herein.

In some examples, a method of making a tree saddle bridge 10 that includes a rope 16 extending between a first end 18 and a second end 20 includes forming a bight 14 in the rope 16 and weaving a plurality of strands 26 around the rope 16 between the bight 14 and the first and second ends 18, 20 to form a sheath 28 around the rope 16.

The present disclosure provides a variety of advantages. First, forming a bight 14 with the portion of the first extent 22 of rope 16 that is between the knot 52 and the intermediate extent 23 of rope 16, the intermediate extent 23 of rope 16, and the portion of the second extent 24 of rope 16 that is between the knot 52 and the intermediate extent 23, and then placing a sheath 28 over the portion of the bight 14 that is engaged by the friction hitch 40 results in a smooth uniform surface along the main body 38 that allows for convenient catch-free sliding of the friction hitch 40 along the main body 38 during use. Second, utilizing the bight 14 within the sheath 28 as referenced above provides a compressible main body 38 that enhances the hold that the friction hitch 40 has on the main body 38 when cinched. Third, utilizing a sheath 28 made of a material, such as nylon rather than relying on a braided polyethylene (for example UHMWPE) to directly interface with the friction hitch 40 increases the ease of sliding the friction hitch 40 relative to the main body 38 for the user. Fourth, using a hollow braided rope 16 for the rope 16 of the main body 38 enhances the compressibility of the main body 38 which helps ensure that the friction hitch 40 does not slip when cinched onto the main body 38. Fifth, by using the methods described herein, the bridge rope assemblies can be produced efficiently, quickly, and consistently. The bridge 10 described herein and constructed by the present methods can be configured to provide advantages, such as being formed without unweaving the sheath 28 or splicing the rope 16.

In some embodiments, in the extended condition of the main body 38, the distance between the first main body end 58 and the second main body end 60 is between about 40 inches and about 46 inches. In some embodiments, in the extended condition of the main body 38, the distance between the first main body end 58 and the second main body end 60 is between about 42 inches and about 44 inches. In some embodiments, in the extended condition of the main body 38, the distance between the first main body end 58 and the second main body end 60 is about 43 inches.

In some embodiments, in the extended condition of the main body 38, the distance between the first main body end 58 and the knot 52 is between about 36 inches and about 44 inches. In some embodiments, in the extended condition of the main body 38, the distance between the first main body end 58 and the knot 52 is between about 39 inches and about 41 inches. In some embodiments, in the extended condition of the main body 38, the distance between the first main body end 58 and the knot 52 is about 40 inches.

In some embodiments, in the extended condition of the main body 38, the distance between the first main body end 58 and the first sheath end 42 is between about 3 inches and about 6 inches. In some embodiments, in the extended condition of the main body 38, the distance between the first main body end 58 and the first sheath end 42 is about 4.5 inches.

In some embodiments, in the extended condition of the main body 38, the distance between the knot 52 and the first sheath end 42 is between about 34 inches and 38 inches. In some embodiments, in the extended condition of the main body 38, the distance between the knot 52 and the first sheath end 42 is about 36 inches.

In some embodiments, in the extended condition of the main body 38, the distance between the knot 52 and the second main body end 60 is between about 1 inch and about 3 inches. In some embodiments, in the extended condition of the main body 38 the distance between the knot 52 and the second main body end 60 is about 1.5 inches.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A method for manufacturing a bridge for a tree saddle, the method comprising:
forming a bight in a rope that extends between a first rope end and a second rope end, wherein the rope includes a first extent extending between the first rope end and an intermediate extent of the rope and a second extent extending between the second rope end and the intermediate extent; and
weaving a plurality of strands around the rope between the first and second rope ends and the intermediate extent to form a sheath around the first and second extents and expose the intermediate extent outside of the sheath.

2. The method of claim 1, comprising:
positioning the intermediate extent between a pair of the plurality of strands prior to weaving the plurality of strands around the rope.

3. The method of claim 1, wherein the bight is formed without splicing the rope.

4. The method of claim 1, wherein the bight is formed without unweaving the sheath.

5. The method of claim 1, comprising:
weaving the plurality of strands together to form a first part of a braid beyond a first sheath end adjacent the bight.

6. The method of claim 5, comprising:
weaving the plurality of strands together beyond the first end and the second end to a position spaced from the rope to form a second part of the braid; and
decoupling each of the first part and the second part from the sheath.

7. The method of claim 1, comprising:
stitching together the sheath and the rope at a first sheath opening adjacent the intermediate extent.

8. The method of claim 7, comprising:
heat-shrinking material around the sheath adjacent the first sheath opening.

9. The method of claim 1, comprising:
heat-shrinking material around the sheath adjacent the first end and the second end.

10. The method of claim 1, comprising:
forming a stopper knot nearer to the first and second ends than to the intermediate extent.

11. The method of claim 10, wherein the bight is defined by a section of the rope that extends along a first portion of the first extent that is between the knot and the intermediate extent, along the intermediate extent, and along a second portion of the second extent that is between the intermediate extent and the knot.

12. The method of claim 11, wherein the rope extends along a rope axis, wherein a first segment of the rope axis extending along an entirety of the first portion is non-colinear with a second segment of the rope axis extending along an entirety of the second portion.

13. A method, comprising:
forming a bend in each of a plurality of ropes that each extend between a first end and a second end, wherein each rope includes a first extent extending between the first rope end and an intermediate extent of the rope and a second extent extending between the second rope end and the intermediate extent;
weaving a plurality of strands around a first rope of the plurality of ropes between the first and second rope ends and the intermediate extent of the first rope to form a first sheath; and
weaving the plurality of strands around a second rope of the plurality of ropes between the first and second rope ends and the intermediate extent of the second rope to form a second sheath.

14. The method of claim 13, comprising:
positioning the intermediate extent of the first rope between a pair of the plurality of strands prior to weaving the plurality of strands around the first rope.

15. The method of claim 13, wherein the intermediate extent of the first rope is formed without splicing the first rope.

16. The method of claim 13, wherein the intermediate extent of the first rope is formed without unweaving the first sheath.

17. The method of claim 13, comprising:
weaving the plurality of strands together to form a first part of a braid beyond the bend of the first rope.

18. The method of claim 17, comprising:
weaving the plurality of strands together beyond the first end and the second end of the first rope to a position spaced from the first rope to form a second part of the braid; and
decoupling each of the first part and the second part from the sheath.

19. The method of claim 13, comprising:
stitching together the first sheath and the first rope at an opening of the first sheath adjacent the intermediate extent.

20. A method for manufacturing bridges for saddles, the method comprising:
forming a bight in each of a plurality of ropes that each extend between a first end and a second end, wherein each rope includes a first extent extending between the first rope end and an intermediate extent of the rope and a second extent extending between the second rope end and the intermediate extent;
weaving a plurality of strands around a first rope of the plurality of ropes between the intermediate extent of the first rope and the first and second ends of the first rope to form a first sheath around the first and second extents of the first rope;
weaving the plurality of strands together beyond the first end and the second end of the first rope to a position spaced from the first rope;
positioning the bight of a second rope at the position spaced from the first rope; and
weaving the plurality of strands around the second rope between the intermediate extent of the second rope and the first and second ends of the second rope to form a second sheath around the first and second extents of the second rope.
